(19) United States
(12) Patent Application Publication
(10) Pub. No.: US 2024/0349341 A1
(43) Pub. Date: Oct. 17, 2024

(54) A User Equipment, a Network and a Method for Providing Improved Transmission

(71) Applicant: Telefonaktiebolaget LM Ericsson (publ), Stockholm (SE)

(72) Inventors: Mohammed Zourob, London (CA); Magnus Sandgren, Staffanstop (SE); Andres Reial, Höllviken (SE); Andreas Kristensson, Södra Sandby (SE)

(21) Appl. No.: 18/580,378

(22) PCT Filed: Jul. 19, 2021
(86) PCT No.: PCT/EP2021/070143

§ 371 Date: Jan. 18, 2024

(51) Int. Cl. H04W 74/0816; H04W 64/00; H04W 74/04

(52) U.S. Cl. CPC H04W 74/0816; H04W 64/00; H04W 74/04

(57) ABSTRACT

A method for scheduling transmissions in a network (300) comprising at least one limited device (100, IoT), a leader device (110) and a network device (200, 210), wherein the method comprises: linking (410) the at least one limited device (100, IoT) to the leader device (110); obtaining (420) first level data for the at least one limited device (100, IoT); obtaining (425) second level data; processing (430) the first level data and second level data for determining (440) at least one transceiving occasion; controlling (450) the at least one limited device (IoT, 100) to be awake (460) for the at least one transceiving occasion.

### TECHNICAL FIELD

The present invention relates to a user equipment, a network and a method for providing improved transmission, and in particular to a user equipment, a network and a method for providing improved transmissions for user equipment having limited capabilities.

### BACKGROUND

Today's communication devices, such as user equipment for example Internet of Things devices, transmit their information based on their specific needs. For example, a device would send a request to a Base Station (BS) asking for an Uplink (UL) grant to transmit. Once the request is granted, resources are allocated for said device (User Equipment (UE)) in order to transmit its information.

Internet of Things (IoT) UEs, e.g. LTE-M and NB-IoT devices, are example of UEs that can be employed in the field to transmit information that are usually not time-critical; for example: periodic transmissions within a certain time period specified by the client, every time they do their requested measurements, or if they accumulate the maximum amount information possible within their memory.

Those devices can be installed on moving vehicles/vessels to do, for example, measurements or track different parameters (stress, temperature, consumption . . . etc.). Such IoT devices may have a nearby more capable device that has a bigger energy resource, positioning information and access to third party geographical map-applications; for example: measurement sensors onboard a train that has an always-connected device.

Traditionally, LTE-M and NB-IoT devices are configured to transmit information either periodically, on a need basis, or once they have to report collected information due to reaching certain operational limits (full storage, low power . . . etc.). These transmission occasions don't always coincide with favorable transmission conditions, whereby they may be required to use high transmission power, stay awake to receive information from BS where transmission from BS to device may be repeated several times due to poor conditions, and/or wake up early or additionally to do time/frequency sync and measurements where the wake-up instance might not be optimal from sleep time maximization viewpoint. This means that those battery-powered devices will have to expend higher amounts of energy than needed.

There is thus a need for a mechanisms to reduce the number of HARQ retransmissions from BS to device during connected mode (and increase the spectral efficiency in general), minimize their transmission power and consequently, the devices wake-up patterns shall be optimized.

### SUMMARY

As discussed above, the inventors have realized that there is a need for a manner to reduce the number of HARQ retransmissions from BS to device during connected mode (and the increase the spectral efficiency in general), minimize their transmission power and consequently, the devices wake-up patterns shall be optimized.

An objective of the present teachings is thus to overcome or at least reduce or mitigate the problems discussed in the above. According to one aspect there is provided a method for scheduling transmissions in a network comprising at least one limited device, a leader device and a network device, wherein the method comprises: linking the at least one limited device to the leader device; obtaining first level data for the at least one limited device; obtaining second level data; processing the first level data and second level data for determining at least one transceiving occasion; controlling the at least one limited device to be awake for the at least one transceiving occasion.

In one embodiment processing the first level data and second level data for determining at least one transceiving occasion is performed by the network device and wherein obtaining second level data is performed by the network device and includes receiving second level data from the leader device.

In one embodiment obtaining first level data includes receiving first level data from the at least one limited device.

In one embodiment obtaining first level data includes receiving first level data for the at least one limited device from the leader device.

In one embodiment obtaining first level data includes retrieving stored first level data.

In one embodiment controlling the at least one limited device to be awake includes the network device controlling the at least one limited device to be awake.

In one embodiment controlling the at least one limited device to be awake includes the network device transmitting the determined at least one transceiving occasion to the leader device and the leader device controlling the at least one limited device to be awake.

In one embodiment processing the first level data and second level data for determining at least one transceiving occasion is performed by the leader device; and obtaining second level data is performed by the leader device determining the second level data.

In one embodiment obtaining first level data for the at least one limited device includes receiving first level data from the at least one limited device.

In one embodiment obtaining first level data for the at least one limited device includes receiving first level data from the network device

In one embodiment controlling the at least one limited device to be awake includes the leader device controlling the at least one limited device to be awake.

In one embodiment controlling the at least one limited device to be awake includes the leader device transmitting the determined at least one transceiving occasion to the network device and the network device controlling the at least one limited device to be awake.

In one embodiment the at least one limited device and the leader device are linked based on mobility measurements.

In one embodiment the at least one limited device and the leader device are linked based on a determined commonality.

In one embodiment the first level data comprises one or more taken from a group comprising mobility measurements for the limited device, receive and transmit occasions/time windows that are needed at specific times, estimated amount of data to be transmitted/received, transmission/reception characteristics, operator/supported frequency bands/access methods, supported Radio Access Technologies, preferred Low/Mid/High band, storage capacity limits, and/or strict transmission/reception periods

In one embodiment second level data comprises one or more taken from a group comprising mobility measurements for the leader device, network load, base station location, base station capability, third party apps data, map data, road planning maps, train track maps, time schedules, previous measurements and/or data regarding past interactions with the network.

Various aspects of a method for a network and of the network, and embodiments and implementations of aspects are disclosed in the description below as well as in the claims.

According to another aspect there is provided a network arranged to schedule transmissions, said network comprising at least one limited device, a leader device and a network device, wherein the method comprises: linking the at least one limited device to the leader device; obtaining first level data for the at least one limited device; obtaining second level data; processing the first level data and second level data for determining at least one transceiving occasion; controlling the at least one limited device to be awake for the at least one transceiving occasion.

According to another aspect there is provided a method for a leader device operating in a network for scheduling transmissions, said network comprising at least one limited device, said leader device and a network device, wherein the method comprises the leader device:

obtaining second level data by determining second level data; determining at least one transceiving occasion based on second level data and first level data for the at least one limited device; controlling the at least one limited device to be awake for the least one transceiving occasion.

In one embodiment determining the at least one transceiving occasion based on second level data and first level data for the at least one limited device includes: transmitting second level data to the network device; and receiving the at least one transceiving occasion.

In one embodiment the method further comprises receiving first level data for the at least one limited device and transmitting first level data to the network device.

In one embodiment determining the at least one transceiving occasion based on second level data and first level data for the at least one limited device includes: receiving first level data for the at least one limited device; and processing the first level data and second level data to determine the at least one transceiving occasion.

In one embodiment receiving first level data for the at least one limited device includes receiving first level data from the at least one limited device.

In one embodiment receiving first level data for the at least one limited device includes receiving first level data from the network device.

In one embodiment controlling the at least one limited device to be awake for the least one transceiving occasion includes transmitting the determined at least one transceiving occasion to the network device. According to another aspect there is provided a leader device operating in a network for scheduling transmissions, said network comprising at least one limited device, said leader device and a network device, wherein the leader device comprises a controller configured to: obtain second level data by determining second level data; determine at least one transceiving occasion based on second level data and first level data for the at least one limited device; and control the at least one limited device to be awake for the least one transceiving occasion.

According to another aspect there is provided a method for a limited device operating in a network for scheduling transmissions, said network comprising the limited device, a leader device and a network device, wherein the method comprises the limited device: transmitting first level data; and being controlled to be awake for at least one transceiving occasion determined based on the first level data. According to another aspect there is provided a limited device operating in a network for scheduling transmissions, said network comprising the limited device, a leader device and a network device, wherein the limited device comprises a controller configured to: transmit first level data; and control the limited device to be awake for at least one transceiving occasion determined based on the first level data. According to another aspect there is provided a method for a network device operating in a network for scheduling transmissions in a network comprising at least one limited device, a leader device and the network device, wherein the method comprises the network device: determining at least one transceiving occasion; controlling the at least one limited device to be awake for the least one transceiving occasion.

In one embodiment the method further comprises: obtaining first level data for the at least one limited device; obtaining second level data; and determining the at least one transceiving occasion by processing the first level data and second level data.

In one embodiment the method further comprises obtaining the second level data by receiving second level data from the leader device.

In one embodiment the method further comprises obtaining first level data for the at least one limited device by receiving first level data from the at least one limited device.

In one embodiment the method further comprises controlling the at least one limited device to be awake for the least one transceiving occasion by transmitting the least one transceiving occasion to the leader device.

In one embodiment the method further comprises determining the at least one transceiving occasion by receiving the at least one transceiving occasion from the leader device.

In one embodiment the method further comprises: receiving first level data for the at least one limited device and transmitting first level data to the leader device.

According to another aspect there is provided a computer-readable medium (810) carrying computer instructions that when loaded into and executed by a controller of a network enables the network to implement a method according to herein.

According to another aspect there is provided a computer-readable medium (810) carrying computer instructions that when loaded into and executed by a controller of a leader device enables the leader device to implement a method according to herein.

According to another aspect there is provided a computer-readable medium (810) carrying computer instructions that when loaded into and executed by a controller of a limited device enables the limited device to implement a method according to herein.

According to another aspect there is provided a computer-readable medium (810) carrying computer instructions that when loaded into and executed by a controller of a network device enables the network device to implement a method according to herein.

The manner taught herein brings about many advantages. The battery-powered (power-limited) devices can now go into deep sleep for longer periods of time instead of waking up at arbitrary time instances to search for suitable cells and transmit their information. Hence the devices can collect their information until either favorable transmission (less transmission power is needed) or better reception conditions (less time spent to receive same amount of data are possible, or in a worst-case scenario, UE limits are reached such as: maximum storage capacity, low battery condition, client set time window . . . etc.

Moreover, since the devices will transmit/receive at favorable locations from the device stand point, for example, if TRX happens at a geographically close point from the BS, then the amount of transmission power used would be considerably lower than the regular case when the device transmits without concern to channel conditions. Moreover, the time needed to transmit/receive a fixed amount of data would generally decrease due to fewer HARQ retransmissions.

In addition, the receiving BS can be informed by a leader device an approximate time of when the battery-powered devices will be in the BS's range, trajectory of movement (not based on prediction but on actual intention of a device's movement via route limits or pre-set map of travel route), mobility information and the number of devices onboard in order to have the BS pre-allocate the necessary resources and optimize (minimize the duration of) the power-limited devices' transmissions.

Moreover, the total time spent in transmitting the same information would be less, since less ramp-ups and ramp-downs will be needed and re-transmissions would be less likely if the IoT devices transmit/receive at the optimal points recommended by the leader device or/and decided by the NW. This is a main advantage which lies in eliminating the multiple ramp ups and ramp down from a wake-up session to only one, which would mean large power savings.

Moreover, even if the less capable devices would need to do some of the processing, that would still be cheaper in power consumption than performing cellular measurements.

### BRIEF DESCRIPTION OF THE DRAWINGS

Embodiments of the invention will be described in the following, reference being made to the appended drawings which illustrate non-limiting examples of how the inventive concept can be reduced into practice.

FIG. 1A shows a schematic view of a limited device according to the teachings herein.

FIG. 1B shows a schematic view of a User Equipment (UE) according to the teachings herein.

FIG. 2A shows a schematic view of a network node, exemplified as a base stations (BS) for example an eNode, according to the teachings herein.

FIG. 2B shows a schematic view of a network entity, exemplified as a Mobility Management Entity (MME), according to the teachings herein.

FIG. 3 shows a schematic view of a general network (NW) according to the teachings herein.

FIG. 4A shows a flowchart for a general method according to the teachings herein.

FIG. 4B shows a flowchart for a general method for a user equipment according to the teachings herein.

FIG. 4C shows a flowchart for a general method for a limited device according to the teachings herein.

FIG. 4D shows a flowchart for a general method for a network device according to the teachings herein.

FIG. 5 shows a schematic view of a computer-readable medium carrying computer instructions that when loaded into and executed by a controller of an arrangement, such as a User Equipment, enables the arrangement to implement an embodiment of the present invention.

FIG. 6A shows a schematic view of example situations according to the teachings herein.

FIG. 6B shows a schematic view of an example situation according to the teachings herein.

FIG. 6C shows a schematic view of an example situation according to the teachings herein.

FIG. 6D shows a schematic view of an example situation according to the teachings herein.

FIG. 6E shows a schematic view of an example situation according to the teachings herein.

FIG. 6F shows a schematic view of an example situation according to the teachings herein.

FIG. 6G shows a schematic view of an example situation according to the teachings herein.

### DETAILED DESCRIPTION

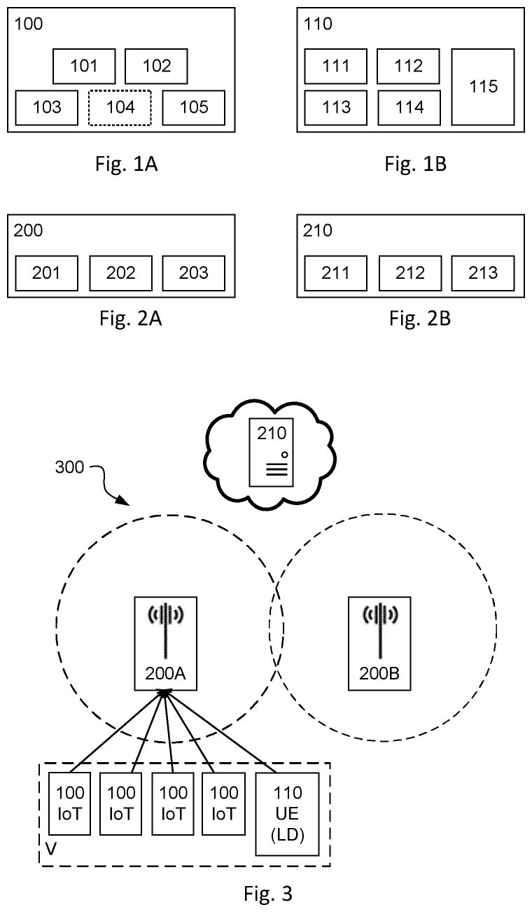

FIG. 1A shows a schematic view of a device 100 according to the teachings herein. In this example the device 100 is a power-limited device (PLD) and is, in one embodiment, arranged to act as an Internet of Things device and will hereafter be referred to as an IoT device 100 limited IoT Device or PLD UE. The IoT device 100 comprises a controller 101, a memory 102, an interface 103, one or more sensors 104 and a power source 105.

The controller 101 is configured to control the overall operation of the IoT device 100. In one embodiment, the controller 101 is a general purpose controller. In one embodiment, the controller 101 is a specific purpose controller. In one embodiment, the controller 101 is a combination of several general purpose controller and/or specific purpose controllers. As a skilled person would understand there are many alternatives for how to implement a controller, such as using Field-Programmable Gate Arrays circuits, ASIC, GPU, NPU etc. in addition or as an alternative. For the purpose of this application, all such possibilities and alternatives will be referred to simply as the controller 101.

The memory 102 is configured to store data such as sensor data, settings and computer-readable instructions that when loaded into the controller 101 indicates how the UE 100 is to be controlled. The memory 102 may comprise several memory units or devices, but they will be perceived as being part of the same overall memory 102.

As a skilled person would understand there are many possibilities of how to select where data should be stored in various memory units and a general memory 102 for the IoT device 100 is therefore seen to comprise any and all such memory units for the purpose of this application. As a skilled person would understand there are many alternatives of how to implement a memory, for example using non-volatile memory circuits, such as EEPROM memory circuits, or using volatile memory circuits, such as RAM memory circuits. For the purpose of this application all such alternatives will be referred to simply as the memory 102.

The communication interface 103 may be wired and/or wireless. The communication interface may comprise several interfaces. A user interface may be comprised in the communication interface 103 of the IoT device 100. Additionally or alternatively, (at least a part of) the user interface may be comprised remotely in the IoT device 100 through the communication interface 103, the user interface then (at least a part of it) not being a physical means in the IoT device 100, but implemented by receiving user input through a remote device (not shown) through the communication interface 103. One example of such a remote device is a mobile phone handset, a tablet computer or a computer.

In one embodiment the communication interface 103 comprises a USB (Universal Serial Bus) interface. In one embodiment the communication interface 103 comprises a HDMI (High Definition Multimedia Interface) interface. In one embodiment the communication interface 103 comprises a Display Port interface. In one embodiment the communication interface 103 comprises an Ethernet interface. In one embodiment the communication interface 103 comprises a MIPI (Mobile Industry Processor Interface) interface. In one embodiment the communication interface comprises an analog interface, a CAN (Controller Area Network) bus interface, an I2C (Inter-Integrated Circuit) interface, or other interface.

In one embodiment the communication interface 103 comprises a radio frequency (RF) communications interface. In one such embodiment the communication interface 103 comprises a Bluetooth™ interface, a WiFi™ interface, a ZigBee™ interface, a RFID™ (Radio Frequency IDentifier) interface, Wireless Display (WiDi) interface, Miracast interface, and/or other RF interface commonly used for short range RF communication. In an alternative or supplemental such embodiment the communication interface 103 comprises a cellular communications interface such as a fifth generation (4G) cellular communication interface, an LTE (Long Term Evolution) interface, a GSM (Global Systéme Mobilé) interface and/or other interface commonly used for cellular communication. In one embodiment the communication interface 103 is configured to communicate using the UPnP (Universal Plug n Play) protocol. In one embodiment the communication interface 103 is configured to communicate using the DLNA (Digital Living Network Appliance) protocol.

In one embodiment, the communication interface 103 is configured to enable communication through more than one of the example technologies given above.

The communications interface 103 may be configured to enable the IoT device 100 to communicate with other devices, such as other IoT devices or one or more UEs 110 such as smartphones, Internet tablets, computer tablets or other computers.

The one or more sensors 104 may comprise any sensors suitable for enabling the IoT device 100 operating as an IoT device, such as temperature sensor, humidity sensors, and acceleration sensors to mention a few examples.

The one or more sensors 104 may alternatively or additionally comprise sensors for determining a position of the IoT device 100, such as a satellite navigation device (for example GNSS or GPS).

The power source 105 may be a power connector arranged to connect to an external power source. Alternatively or additionally the power source 105 is a battery. The power source is associated with a power capability. The power capability may be limited by a batter life time or by the current being supplied by the external power source.

FIG. 1B shows a schematic view of a User Equipment (UE) 111 according to the teachings herein. The UE 110 comprises a controller 111, a memory 112, an interface 113, one or more sensors 114 and a power source 115.

The controller 111 is configured to control the overall operation of the UE 110. In one embodiment, the controller 111 is a general purpose controller. In one embodiment, the controller 111 is a specific purpose controller. In one embodiment, the controller 111 is a combination of several general purpose controller and/or specific purpose controllers. As a skilled person would understand there are many alternatives for how to implement a controller, such as using Field-Programmable Gate Arrays circuits, ASIC, GPU, NPU etc. in addition or as an alternative. For the purpose of this application, all such possibilities and alternatives will be referred to simply as the controller 111.

The memory 112 is configured to store data such as sensor data, settings and computer-readable instructions that when loaded into the controller 111 indicates how the UE 110 is to be controlled. The memory 112 may comprise several memory units or devices, but they will be perceived as being part of the same overall memory 112.

As a skilled person would understand there are many possibilities of how to select where data should be stored in various memory units and a general memory 112 for the UE 110 is therefore seen to comprise any and all such memory units for the purpose of this application. As a skilled person would understand there are many alternatives of how to implement a memory, for example using non-volatile memory circuits, such as EEPROM memory circuits, or using volatile memory circuits, such as RAM memory circuits. For the purpose of this application all such alternatives will be referred to simply as the memory 112.

The communication interface 113 may be wired and/or wireless. The communication interface may comprise several interfaces. A user interface may be comprised in the communication interface 113 of the UE 110. Additionally or alternatively, (at least a part of) the user interface may be comprised remotely in the UE 110 through the communication interface 113, the user interface then (at least a part of it) not being a physical means in the UE 110, but implemented by receiving user input through a remote device (not shown) through the communication interface 113. One example of such a remote device is a game controller, a mobile phone handset, a tablet computer or a computer.

In one embodiment the communication interface 113 comprises a USB (Universal Serial Bus) interface. In one embodiment the communication interface 113 comprises a HDMI

(High Definition Multimedia Interface) interface. In one embodiment the communication interface 113 comprises a Display Port interface. In one embodiment the communication interface 113 comprises an Ethernet interface. In one embodiment the communication interface 113 comprises a MIPI (Mobile Industry Processor Interface) interface. In one embodiment the communication interface comprises an analog interface, a CAN (Controller Area Network) bus interface, an I2C (Inter-Integrated Circuit) interface, or other interface.

In one embodiment the communication interface 113 comprises a radio frequency (RF) communications interface. In one such embodiment the communication interface 113 comprises a Bluetooth™ interface, a WiFi™ interface, a ZigBee™ interface, a RFID™ (Radio Frequency IDentifier) interface, Wireless Display (WiDi) interface, Miracast interface, and/or other RF interface commonly used for short range RF communication. In an alternative or supplemental such embodiment the communication interface 113 comprises a cellular communications interface such as a fifth generation (4G) cellular communication interface, an LTE (Long Term Evolution) interface, a GSM (Global Systéme Mobilé) interface and/or other interface commonly used for cellular communication. In one embodiment the communication interface 113 is configured to communicate using the UPnP (Universal Plug n Play) protocol. In one embodiment the communication interface 113 is configured to communicate using the DLNA (Digital Living Network Appliance) protocol.

In one embodiment, the communication interface 113 is configured to enable communication through more than one of the example technologies given above.

The communications interface 113 may be configured to enable the UE 110 to communicate with other devices, such as other UEs 110 such as smartphones, Internet tablets, computer tablets or other computers, media devices, such as television sets, gaming consoles, video viewer or projectors (not shown), or Internet of Things devices.

The one or more sensors 114 may comprise any sensors suitable for enabling the UE 110 operating as an IoT device, such as temperature sensor, humidity sensors, and acceleration sensors to mention a few examples.

The one or more sensors 114 may alternatively or additionally comprise sensors for determining a position of the UE 110, such as a satellite navigation device (for example GNSS or GPS).

The power source 115 may be a power connector arranged to connect to an external power source. Alternatively or additionally the power source 115 is a battery. The power source is associated with a power capability. The power capability may be limited by a batter life time or by the current being supplied by the external power source.

Although technically, the IoT device is a User Equipment as per how the terminology is used in communication standards, the UE of FIG. 1B will be referred to as a UE herein and the device of FIG. 1A will be referred to as a IoT device. As is indicated in FIGS. 1A and 1B, the IoT device 100 is limited, especially as comes to power resources, whereas the UE does not suffer from the same limitations. This is indicated in the figures by the power source 115 of the UE 110 being illustrated as bigger than the power source 105 of the IoT device 100.

FIG. 2A shows a schematic view of a network node 210, exemplified as a base stations (BS) for example an eNode, according to the teachings herein.

The BS 210 comprises a controller 211, a memory 212, and an interface 213. The controller 211 is configured to control the overall operation of the BS 210. In one embodiment, the controller 211 is a general purpose controller. In one embodiment, the controller 211 is a specific purpose controller. In one embodiment, the controller 211 is a combination of several general purpose controller and/or specific purpose controllers. As a skilled person would understand there are many alternatives for how to implement a controller, such as using Field-Programmable Gate Arrays circuits, ASIC, GPU, NPU etc. in addition or as an alternative. For the purpose of this application, all such possibilities and alternatives will be referred to simply as the controller 211.

The memory 212 is configured to store data such as settings and computer-readable instructions that when loaded into the controller 211 indicates how the BS 210 is to be controlled. The memory 212 may comprise several memory units or devices, but they will be perceived as being part of the same overall memory 212.

As a skilled person would understand there are many possibilities of how to select where data should be stored in various memory units and a general memory 212 for the BS 210 is therefore seen to comprise any and all such memory units for the purpose of this application. As a skilled person would understand there are many alternatives of how to implement a memory, for example using non-volatile memory circuits, such as EEPROM memory circuits, or using volatile memory circuits, such as RAM memory circuits. For the purpose of this application all such alternatives will be referred to simply as the memory 212.

In one embodiment the communication interface 213 comprises a radio frequency (RF) communications interface used for connecting a UE to a BS in cellular communication such as a fifth generation (4G) cellular communication interface, an LTE (Long Term Evolution) interface, a GSM (Global Systéme Mobilé) interface and/or other interface commonly in cellular communication.

FIG. 2B shows a schematic view of a network entity 220, exemplified as a Mobility Management Entity (MME), according to the teachings herein. The MME 220 comprises a controller 221, a memory 222, and an interface 223. The controller 221 is configured to control the overall operation of the MME 220. In one embodiment, the controller 221 is a general purpose controller. In one embodiment, the controller 221 is a specific purpose controller. In one embodiment, the controller 221 is a combination of several general purpose controller and/or specific purpose controllers. As a skilled person would understand there are many alternatives for how to implement a controller, such as using Field-Programmable Gate Arrays circuits, ASIC, GPU, NPU etc. in addition or as an alternative. For the purpose of this application, all such possibilities and alternatives will be referred to simply as the controller 221.

The memory 222 is configured to store data such as settings and computer-readable instructions that when loaded into the controller 221 indicates how the MME 220 is to be controlled. The memory 222 may comprise several memory units or devices, but they will be perceived as being part of the same overall memory 222.

As a skilled person would understand there are many possibilities of how to select where data should be stored in various memory units and a general memory 222 for the MME 220 is therefore seen to comprise any and all such memory units for the purpose of this application. As a skilled person would understand there are many alternatives of how to implement a memory, for example using non-volatile memory circuits, such as EEPROM memory circuits, or using volatile memory circuits, such as RAM memory circuits. For the purpose of this application all such alternatives will be referred to simply as the memory 222.

In one embodiment the communication interface 223 comprises a radio frequency (RF) communications interface used for connecting a MME to a BS in cellular communication such as a fifth generation (4G) cellular communication interface, an LTE (Long Term Evolution) interface, a GSM (Global Systéme Mobilé) interface and/or other interface commonly in cellular communication.

FIG. 3 shows a schematic view of a general network (NW) 300 according to the teachings herein. The network 300 comprises one or more network nodes 200, 210, such as one or more base stations (BS) 200 and/or one or more network entities 210, such as a Mobility Management Entity (MME), arranged for serving and providing telecommunications network capabilities to a plurality of IoT devices 100 and one or more User Equipment 110.

As discussed in the above, a UE 110 has high capabilities, as regards power capabilities of the power source 115, processing capabilities of the controller 111, memory space of the memory 112, bandwidth of the interface 113, and/or complexity of the sensor(s) 114. And, an IoT device 100 has lower capabilities, where a low capability indicates a lower capability than the corresponding capability of a UE 100 having high capabilities. Such IoT devices 100 having low capabilities are hereafter also referred to as limited devices. In the example of FIG. 3, the UE 110 having high capabilities is grouped with a plurality (in this case 4) IoTs 100. The UE 110 is in this example referred to as the leader device (LD) 110 of the grouping.

The UE 110 and IoTs 100 that are grouped may be grouped based on a spatial locality (at least spatial locality over a time period), such as travelling in the same vehicle V as in the example of FIG. 3. There are different manners of determining the grouping and some will be discussed in further detail in the below.

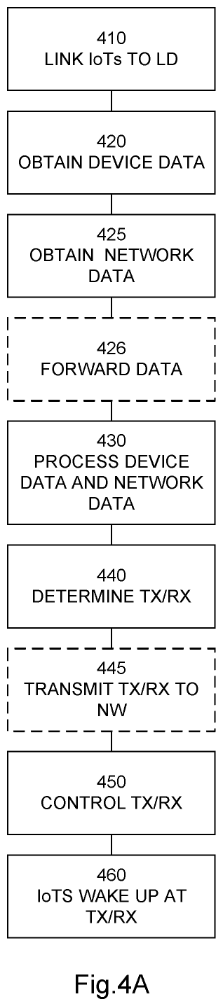

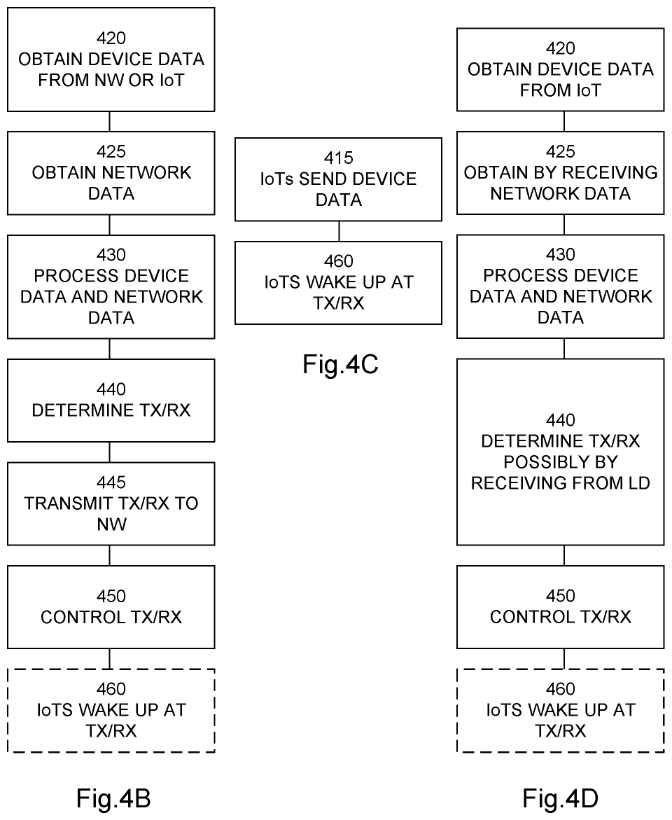

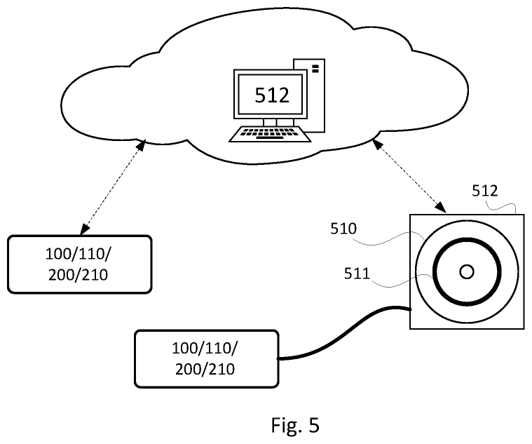

Referring to FIG. 3 and FIG. 4A showing a flowchart for a general method according to herein, there is provided a manner herein for improved transmission management for IoT devices 100 operating in the network 300, wherein a dependency is determined between one or more IoTs (i.e. limited devices) 100 and a User Equipment 110, by linking (and thereby grouping) 410 the IoTs 100 to the User Equipment 110, the User Equipment 110 being a Leader Device 110 for the grouping.

Thereafter first level data is obtained 420 for the at least one limited device 100. The first level data is data related to the IoT device and will be exemplified in greater detail below. Second level data is also obtained 425, wherein second level data is data related to the leader, the network or the environment and will be exemplified in greater detail below.

The first level data and second level data is processed 430 for determining 440 at least one transceiving occasion. A transceiving occasion may be a transmission point and/or at least one reception point, where a point may be a point in time and/or a point in space. A point in space may be a time window and a point in space may be an area. The at least one limited device 100 is then controlled 450 to be awake 460 for the at least one transceiving occasion.

In some embodiments a network device, such as a base station or a Network Management Node 210 is arranged to obtain the data and to process 430 the first level data and second level data for determining 440 the at least one transceiving occasion: in such embodiments, obtaining 425 the second level data is also performed by the network device 200, 210 and includes receiving second level data from the leader device 110.

In some such embodiments the first level data is obtained by being received from the at least one limited device 100. And in some such alternative or additional embodiments the first level data is received from the leader device 110.

In some embodiments, obtaining 420 first level data includes retrieving stored first level data.

In some embodiments, the network device controls the IoT 100 to be awake 460. The first level data is thus sent from the IoT 100 to the Leader device 110 and/or the network. Depending on the connections available, the IoT 100 may send the data to one entity (LD or NW) which then may forward 426 to the other entity (LD or NW).

In some embodiments, the leader device controlling the limited device IoT 100 to be awake 460 includes the network device 200, 210 transmitting 445 the determined at least one transceiving occasion to the leader device 110 and the leader device 110 controlling the at least one limited device IoT 100 to be awake 460.

In some embodiments, the leader device 110 determining the transmission occasion and processing 430 the first level data and second level data for determining 440 at least one transceiving occasion is thus performed by the leader device 110. And, in such an embodiment the second level data is obtained 425 by the leader device 110 determining the second level data. The first level data for the at least one limited device IoT 100 may be obtained by being received 420 from the at least one limited device IoT 100 and/or from the network device (200, 210). It should be noted that determining data does not necessarily include deciding to use the data, but it may only be to determine (as in generate) for recommending the data to be used.

As stated above, in some such embodiments, the leader device 110 controls the at least one limited device IoT 100 to be awake 460 as the transmission occasion is determined. However, the leader device may also or alternatively transmit 445 the transmission occasion to the network for enabling the network to control the IoT 100 to be awake.

As discussed above, the IoTs 100 and the UE may be linked in different manners. In some example embodiments the at least one limited device IoT 100 and the leader device (110) are linked based on mobility measurements. In some embodiments the at least one limited device IoT 100 and the leader device 110 are linked based on a determined commonality, such as a common destination or common shipping parameters that may be determined through a shipping application (such as a scanning software).

In some embodiments the first level data comprises one or more taken from a group comprising mobility measurements for the limited device IoT 100, receive and transmit occasions/time windows that are needed at specific times, estimated amount of data to be transmitted/received, transmission/reception characteristics, for example transmission power, operator/supported frequency bands/access methods, supported Radio Access Technologies, preferred Low/Mid/High band, storage capacity limits, and/or strict transmission/reception periods.

In some embodiments the second level data comprises one or more taken from a group comprising mobility measurements for the leader device 110, network load, base station location, base station capability, third party apps data, map data, road planning maps, train track maps, time schedules, previous measurements and/or data regarding past interactions with the network 300.

There is thus provided a network 300 arranged to schedule transmissions, said network 300 comprising at least one limited device IoT 100, a leader device 110 and a network device 200, 210, wherein one or more of the components of the network perform: linking 410 the at least one limited device IoT 100 to the leader device 110; obtaining 420 first level data for the at least one limited device IoT 100; obtaining 425 second level data; processing 430 the first level data and second level data for determining 440 at least one transceiving occasion; controlling 450 the at least one limited device IoT 100 to be awake 460 for the at least one transceiving occasion.

Referring to FIG. 1B and FIG. 4B showing a flowchart for a general method according to the manner taught herein for a leader device 110 operating in a network 300 for scheduling transmissions. The leader device 110 obtains second level data 425 by determining second level data and determines 440 at least one transceiving occasion based on second level data and first level data for the at least one limited device IoT 100 (which may be one when lining 410), and thereafter controls 450 the at least one limited device IoT 100 to be awake for the least one transceiving occasion.

In some embodiments the data is processed by the network but the leader device controls the IoT 100 and determining 440 the at least one transceiving occasion based on second level data and first level data for the at least one limited device IoT 100 then includes transmitting second level data to the network device 200, 210; and receiving the at least one transceiving occasion.

In some embodiments the leader device may also obtain by receiving 420 first level data for the at least one limited device IoT 100 (which may be one when lining 410) and transmit or forward the first level data to the network device 200, 210.

In some embodiments the leader device processes the data determines the transceiving occasion, wherein determining 440 the at least one transceiving occasion based on second level data and first level data for the at least one limited device IoT 100 includes receiving 420 first level data for the at least one limited device IoT 100 and processing 430 the first level data and second level data to determine 440 the at least one transceiving occasion. In some embodiments obtaining by receiving 420 first level data for the at least one limited device IoT 100 includes receiving 420 first level data from the at least one limited device IoT 100. In some embodiments receiving 420 first level data for the at least one limited device IoT 100 includes receiving 420 first level data from the network device 200, 210.

In some embodiments the leader device processes the data, but the network device controls the IoT and in such embodiments controlling 450 the at least one limited device IoT 100 to be awake for the least one transceiving occasion includes transmitting 445 the determined at least one transceiving occasion to the network device 200, 210. The controlling 450 is marked as option in FIG. 4B as it may be indirect by transmitting the transceiving occasion to the network for control.

Referring to FIG. 1A and FIG. 4C showing a flowchart for a general method according to the manner taught herein for a limited IoT device 100 operating in a network 300 for scheduling transmissions. The limited device IoT 100 transmits or sends 415 first level data to the leader device and/or to the network device. The limited IoT device 100 is then controlled 450 to be awake 460 for at least one transceiving occasion determined based on the first level data by either the leader device and/or the network device 200, 210.

Referring to FIGS. 2A and 2B and FIG. 4d showing a flowchart for a general method according to the manner taught herein for a network device, such as a base station 200 or a network management node 210 operating in a network 300 for scheduling transmissions. The network device 200, 210 is configured for determining 440 at least one transceiving occasion and controlling 450 the at least one limited device IoT 100 to be awake 460 for the least one transceiving occasion.

In some embodiments, the network device is configured for obtaining 420 first level data for the at least one limited device IoT 100, obtaining second level data 425 and determining 440 the at least one transceiving occasion by processing 430 the first level data and second level data. The network device 200, 210 is further configured for controlling 450 the at least one limited device IoT 100 to be awake 460 for the least one transceiving occasion.

In some embodiments obtaining the second level data 425 is done by receiving second level data from the leader device 110. In some embodiments obtaining 420 first level data for the at least one limited device IoT 100 is done by receiving first level data from the at least one limited device IoT 100.

In some embodiments the network device 200,210 is further configured for controlling 450 the at least one limited device IoT 100 to be awake 460 for the least one transceiving occasion by transmitting the least one transceiving occasion to the leader device 110.

In some embodiments determining 440 the at least one transceiving occasion is done by receiving the at least one transceiving occasion from the leader device 110.

In some embodiments the network device 200,210 obtains by receiving 420 first level data for the at least one limited device IoT 100 and transmits the first level data to the leader device (110).

FIG. 5 shows a schematic view of a computer-readable medium 510 carrying computer instructions 511 that when loaded into and executed by a controller 101 of an arrangement, such as a UE 100, an IoT 100, or a network device 200,210, enables the arrangement to implement an embodiment of the present invention.

The computer-readable medium 510 may be tangible such as a hard drive or a flash memory, for example a USB memory stick or a cloud server. Alternatively, the computer-readable medium 510 may be intangible such as a signal carrying the computer instructions enabling the computer instructions to be downloaded through a network connection, such as an internet connection.

In the example of FIG. 5, a computer-readable medium 510 is shown as being a computer disc 510 carrying computer-readable computer instructions 511, being inserted in a computer disc reader 512. The computer disc reader 512 may be part of a cloud server 520—or other server—or the computer disc reader may be connected to a cloud server 520—or other server. The cloud server 520 may be part of the internet or at least connected to the internet. The cloud server 520 may alternatively be connected through a proprietary or dedicated connection. In one example embodiment, the computer instructions are stored at a remote server 520 and be downloaded to the memory 102 of the UE 100 for being executed by the controller 101. The same applies to an IoT 100 or a network device 200,210.

The computer disc reader 512 may also or alternatively be connected to (or possibly inserted into) an object detection arrangement 100 for transferring the computer-readable computer instructions 511 to a controller of the UE 100 (presumably via a memory of the object detection arrangement 100).

FIG. 5 shows both the situation when a UE 100, an IoT 100, or a network device 200, 210 receives the computer-readable computer instructions 511 via a server connection and the situation when another UE 100, an IoT 100, or a network device 200, 210 receives the computer-readable computer instructions 511 through a wired interface. This enables for computer-readable computer instructions 511 being downloaded into a UE 100, an IoT 100, or a network device 200, 210 thereby enabling the UE 100, an IoT 100, or a network device 200, 210 to operate according to and implement the invention as disclosed herein.

Even though the discussion herein regarding computer-readable mediums have been focused on UEs, the same applies to other network components such as base stations or network entities.

References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

In the following, several embodiments and implementations of the general teaching disclosed above will be discussed in detail. What is discussed below is not instead of what is discussed above, but supplemental and in addition to what is discussed above. As discussed in the above the teachings herein provide for cooperation between a leader device and one or more power-limited devices (PLDs or IoTs) where the leader device determines preferred time instances or other transceiving occasions for PLD data transmission/reception and indicates those to the PLDs. As noted above, the leader device may determine the instances and occasions for later decision by a network node. Also, the network node may be the device determining the instances and occasions and deciding on them as well.

While the power limited devices are asleep and preserving their energy, the leader device obtains positioning information, may know the route (in pre-determined paths like on a train track, shipping container, delivery truck), or get route plans (e.g. from third party apps Google maps, WAZE, Apple Maps, . . . etc.). In that case, the leader can determine when the convoy would be advantageously close to (or under other beneficial signaling conditions with) a base station (BS) and wake up the (possibly through a delegation of this task to a network node) power-limited devices for data exchange (subject to any use case-specific latency/delay constraints). Optionally, the leader may inform the said BS about the number and type of devices, to aid efficient NW resource usage.

The leader can determine the advantageous situation of transmission with respect to the BS using several resources amongst which but not limited to (Second level data):
1) Mobility measurements.
2) Third party apps such as, and not limited to, Google Maps and Waze.
3) Highway planning maps including exits and mergers into highway.
4) Train tracks layout maps.
5) Previous measurement reporting of the leader device (used this route before).
6) Interaction with network: The network could base its decision to wake up the devices for transmission based on many previous reported IoT measurements on the “path” taken by the vessel carrying the many devices and the leader device. Moreover, this may be incorporated with device positioning. Hence, either the leader device reports its position and its planned route at a specific time, the IoTs which don't have the position reporting capability can get their position reported through the leader device via a connection between the two that can be implemented by some form of App/Agent, or the leader gets a list of PLD UEs or IoT that will be in the leader's vicinity for a certain period of time via local scanning (e.g. UPS scanning their packages that are going on a certain vessel or truck).

The handshake between the IoTs and their leader/NW can be used to share the following information (First level):
Receive and transmit occasions/time windows that are needed at specific times.
Estimated amount of transmit/receive data.
Tx/Rx characteristics like Tx power if applicable.
Operator/supported frequency bands/access methods.
Preferred Low/Mid/High band
Storage capacity limits.
Strict transmission/reception periods set by the owner of the device.

The above mentioned information from both leader and PLD UEs can be pushed to the BS and the NW can do all the processing and control in such case.

The leader may also share its mobility measurements with power-limited devices in a D2D fashion so they will not have to do the measurements themselves at their regular periodicity. The sharing feature of mobility measurements, for PLD to skip the mobility measurement step, can happen in one of two forms:
New standardized handshake via NW: could support both linking and wake-up.
Higher level application that runs at both leader and linked UEs: handles linking (cellular or non-cellular means).

The sharing feature of second level and/or first level data can happen in one of three forms:
M1. New standardized handshake via NW: could support both linking and wake-up.
M2. Higher level application protocol that runs at both leader and linked IoTs: handles linking (cellular (D2D) or non-cellular means), and also take control of data TRX in IoTs so that it triggers paging and data requests at a suitable time and blocks receiving data at other times as long as it is not time sensitive.
M3. If no D2D connection is established or possible, then the IoT devices can do the measurements themselves while remaining in idle, and communicate their needs to the BS using regular data packets or via a new standardized 3GPP signaling specific for IoT devices or PLD UEs. In that case:

Either the leader gets the PLD UEs information from the BS, do the processing and monitoring, and inform the BS to wake up the said devices at advantageous points in time that are governed by a list of priorities.

Or the leader transmits its information (measurements, route . . . etc.) and let the BS/NW do the processing, controlling and selecting advantageous TRX points.

The IoT devices would mostly be measuring periodically with constant intervals. Hence, the storage capacity of said devices can be known ahead of time by the leader device and/or the NW. Given this information, optimal transmission locations/instants, final optimal transmission point before storage and/or runs out, then the leader can decide when to wake up those devices, ask the BS to schedule a transmission allocation, or the BS can decide on the next TRX point. E.g. memory cost and power for storing some data (at least up to 10 s or 100 s of MB) while waiting for a transmission opportunity is relatively low.

One key difference here from transmitting the information directly to the leader device, as a gateway, is preserving security/privacy, mitigating issues arising from vendors' different implementations and avoiding the single point of failure scenario. In addition, there are legal consequences to having a proxy to relay the information, as the proxy will need to store all information that gets relayed through it to comply with security concerns.

In the proposed scheme, the leader or the BS/NW act as an optimizer for the Tx/Rx instances for the surrounding devices, but those devices still have the ability to override/ignore this optimization mechanism and fall back on the standardized way of operating as a fail-safe measure.

The positions of the leader and less capable devices are assumed to be close to each other in order to have similar environments. The leader device is assumed to be travelling with the less capable devices.

It is important to note here that the proposed solution is not a D2D solution. D2D is cellular and targets data transfer until it reaches the BS. The proposed idea here does not involve data transfer/exchange. It focuses more on processing different input information to do better utilization of resources on the BS and the less capable device sides.

In one embodiment, the solution is dependent on having a single leader device in connected mode most of the time, this is possible since the leader is selected based on its capability and resources for performing described tasks. Trying to implement the solution among the less capable devices would mean that one device would take all the punishment and not meet its expected lifetime for the sake of the other devices.

In an alternative embodiment, the leader device responsibility may be shared among multiple PLD devices that have the necessary capabilities of transmitting at least its position, e.g. in a round robin fashion over time, to ensure negligible degradation in lifetime expectancy for each individual less capable devices.

Actions by the leader comprise the following (not all steps executed in all embodiments):

Establishing a connection with PLDs if possible, e.g. via D2D, standardized NW procedure, or higher level over the top application,

Obtaining capability, latency tolerance, traffic type, and other operational requirement/preference info from PLDs either via the sidelinks or from the BS/NW.

Either this information is obtained at the leader side,

Or is obtained at the BS/NW side: In this case the leader also transmits its route info in response to third party apps, positioning, measurements, etc.

On the leader or the BS sides: Determining favorable data TRX condition instances for PLDs, e.g. ad-hoc based on current channel measurements, or planned based on historic or expected route information, BS location info in relation to the route, . . . etc, favorable conditions may include e.g. strong link quality to a BS, low NW load and expected short data handling duration, low interference, etc. The favorable instance may also subject to maximum allowed delays between PLD data sessions, e.g. an instance may be deemed favorable if necessary due to delay constraints even if the current link conditions are not preferred,
Signaling to PLDs to perform data TRX at the favorable data TRX instances,
Optional (for further power savings): Performing idle mode measurements and providing the measurement results to PLDs in similar/compatible link conditions, including establishing/verifying the similarity wrt. the PLDs,

Actions by the PLDs comprise the following (again not all items may be performed):
Establishing connection with leader if possible, e.g. via D2D, non-cellular connection, new standardized NW procedure, or third-party over the top application,
Providing capability, latency tolerance, traffic type, and other operational requirement/preference info to leader or NW based on the implementation,
Obtaining from leader or BS/NW a signal to perform data TRX at favorable data TRX instances and performing such data TRX, e.g. sensor or tracking data collected since last data TRX instance,
Optional: Receiving idle mode measurements results from leader in similar/compatible link conditions, including establishing/verifying the similarity wrt. the leader,

The processing of first level data by the NW or the leader produces a priority list. Priority order would decide when and where the less capable devices would transmit/receive information. Parameters that decide the priority can be, but not limited to, the following:
Approaching storage capacity limits.
Strict transmission/reception periods set by the owner of the device.
Resource's availability at the targeted BS for Tx/Rx.
Pre-determined calculated optimal points of Tx/Rx: favorable conditions may include e.g. strong link quality to a BS, low NW load and expected short data handling duration, low interference, etc.

Starting from the bottom of the list, if any of the bottom bullets violates any of the upper bullets, then transmission must be performed according to the higher priority bullet.

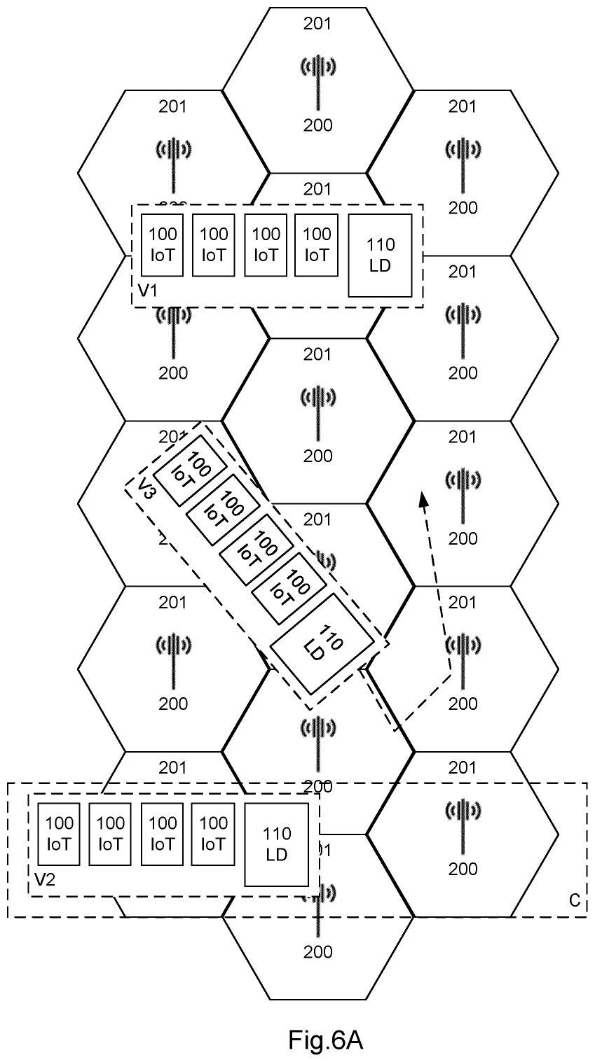

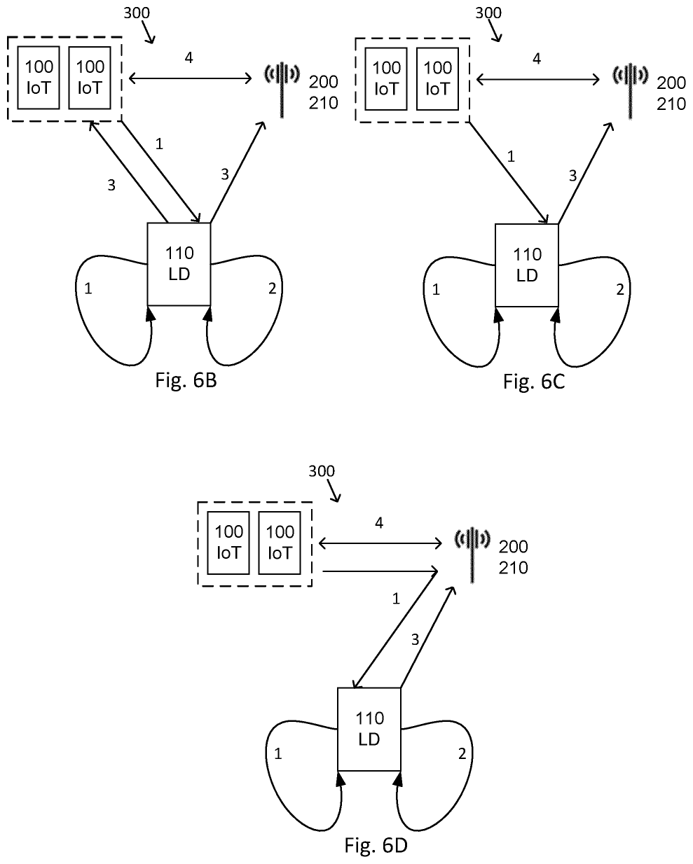

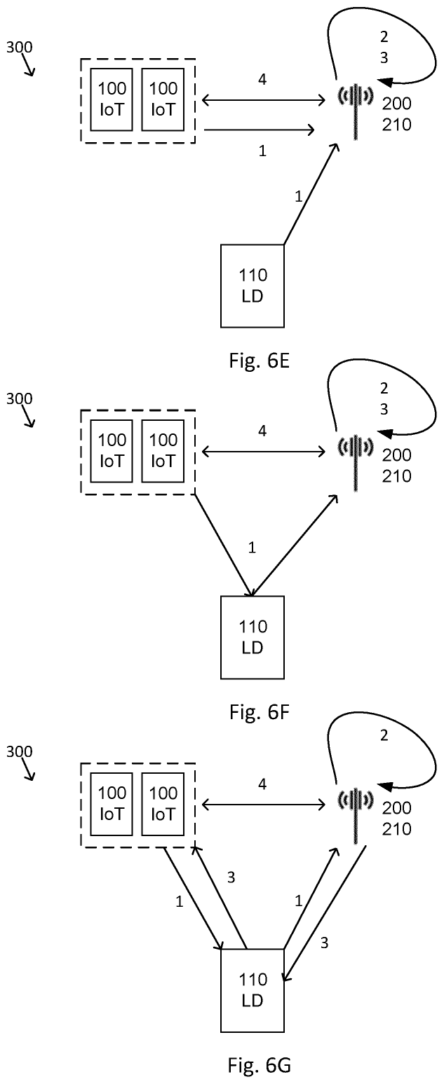

With reference to FIGS. 6A to 6G example scenarios will be discussed where various implementations of the teachings herein is used beneficially.

FIG. 6A shows a general situation where a plurality of IoTs 100 are linked to a leader device 110 on a vehicle moving through a network 300 comprising several base stations 200 each serving a cell 201. The base station is an example of a network device 200, 210. Scenario 1: Train V1 equipped with different types of sensors (for example: stress or temperature sensors, speed and equipment decay monitoring, etc.). An onboard leader device 110 would have access to information such as the train track system, train route, points at which the train would have minimum distance to the route BSs and received reference signal quality for cases with blocking obstacles. This is necessary in cases where one cell might be favorable based on distance, but the signal quality would be bad because of huge blockage environments. In that case, another Cell with greater distance to BS 200 and better overall signal quality would be a better candidate to transmit to with lower signal transmission power. The BS controller (BSC) that controls several BSs would govern this operation. This function can be managed and controlled in different scenarios (can be applied to all the deployment example scenarios), to mention a few (might require standardization within 3GPP):
1) Either the leader device establishes a link to the surrounding IoT devices 100 in a D2D fashion. The leader device share information with the surrounding IoT devices on the preferred transmission/reception points. Devices take the information and decide based on its needs whether to transmit or receive. Acknowledgment is only sent to the leader device to inform it that an IoT device 100 will need to transmit. The leader then informs the BS 200 of devices that will be scheduled to transmit soon. Based on that, the BS 200 can better schedule resources for the soon to transmit/receive devices. The information to be shared between the leader and the IoT devices 100 have been covered previously. The leader device determines recommendations for when to wake up the IoT devices 100 based on their settings that will be communicated in this case to the NW every time they are set or changed; prioritize sending information on time vs energy efficiency. This information can be communicated between the two devices using the cellular network or some other lower power communication link such as BLE mesh.
2) Or the leader device 100 on a truck or train V1 would get the information of onboard IoT devices 110. A third party application can be used to scan IoT identifiers that will be permanently installed on a vessel, or simply scan IoT devices 100 that come on-board and scan them again once they leave (scenarios: DHL truck delivering packages, Train door equipped with read scanner to identify packages coming on board and packages getting off). The scanned information is sent via the third party application to the leader device. Now, the leader device reports back to the BS the preferred points of transmission/reception. The BS 200, which knows which IoT devices 100 are in the vicinity of the leader device 110, then allocates resources and wakes up IoT devices 100 that are linked to the leader device 110 to transmit/receive. The burden of making the decision falls on the NW in this scenario, as it will decide when to wake up the IoT devices based on their settings that will be communicated in this case to the NW every time they are set or changed; prioritize sending information on time vs energy efficiency.

Moreover, based on the received signal quality, the BSC would be able to identify unexpected events or anomalies that effect the communication between the candidate BS and the onboard IoT devices. This would be used to adjust candidate BSs for future trains/devices to update their location of transmission preference. Hence, for each leader device there would be a list of transmission points preferences that takes into account the route of the train. As long as the IoT devices did not hit their maximum storage capacity, power threshold before total shutdown, or a time reporting criterion that is set by the client, then the leader device can be set to wake up the IoT devices to transmit their information to the candidate BS based on the transmission preference list. The transmission preference list sets the priority of the IoT devices' transmission scheme. Assume we are using the first management and control scheme for this proposal, where a D2D link is established between the leader and the IoT devices. Once the IoT devices get the information about the preferred point of transmission, they can decide whether to wait for that point, or simply transmit in order to meet the client's demand to receive information at a certain time-stamp that is before the preferred transmission point. Then the device choses to prioritize sending the information at the client's preference. This would be a feature eventually that the client can change later on. For applications that are not time-sensitive, the devices can be given the freedom to send information while prioritizing power/energy.

In addition, given enough statistical information using received signal quality indicators and IoT devices transmission limitations, the BSC can anticipate which BS would be best suited for the IoT transmission. Therefore, the candidate BS can pre-allocate resources in anticipation of the expected arrival of a number of IoT devices within its range.

Scenario 2: A truck that delivers different goods/containers (fruits, vegetables, diary . . . etc.) requires different types of sensors (temperature, humidity, light, gases . . . etc.) to monitor the condition of the goods/products and the equipment used to keep those goods preserved. Similar to Scenario 1, the truck V2 would be mostly driven on a well-known pre-determined paths or corridors C (highways). The installed IoT devices 100 will be permanent on such a truck/vessel V2. So, it would be expected that those battery-powered IoT sensors would stay operational for several years. Hence, using a leader device that's powered by and onboard the truck/vessel, the previously explained system would be used to transmit the IoT devices' information at the most power efficient point geographically and in a timely manner.

Scenario 3 is similar to Scenario 2, however, the vessel V3 is taking a more random path compared to the previous scenarios, as indicated by the arrow. In such case, the leader device 110 could be equipped with one of the many third-party maps services such as: Google Maps or WAZE. The leader device would hence extract the information from the third-party app and relay the information to the BSC to be used in planning its list of transmission preference list.

FIG. 6B shows an example situation where a plurality (exemplified by two) IoTs 100 are linked to a leader device 110 being serviced in a network comprising at least one network device 200, 210. In this example the leader device 110 receives first level data from the IoTs 100 and substantially simultaneously determines its own second level data in a first step as indicated by the arrows marked 1. In a second step, the data is processed at the leader device 110 as indicated by the arrow marked 2 to determine transceiving occasion (TX/RX). And the transceiving occasion is then communicated to the IoTs 100 in case the leader device is to wake them up, or to the network in case the network is to wake up the IoTs as indicated by the arrows marked 3 so the IoTs are controlled to be awaken and to transmit and/or receive as indicated by the arrow marked 4. In one embodiment, the communication is via a M1 protocol as discussed above. In one embodiment, the communication is via a M2 protocol as discussed above.

FIG. 6B shows an example situation where a plurality (exemplified by two) IoTs 100 are linked to a leader device 110 being serviced in a network comprising at least one network device 200, 210. In this example the leader device 110 receives first level data from the IoTs 100 and substantially simultaneously determines its own second level data in a first step as indicated by the arrows marked 1. In a second step, the data is processed at the leader device 110 as indicated by the arrow marked 2 to determine transceiving occasion (TX/RX). And the transceiving occasion is then communicated to the IoTs 100 as the leader device is to wake them up as indicated by the arrows marked 3 so the IoTs are controlled to be awaken and to transmit and/or receive as indicated by the arrow marked 4. In any case, the transceiving occasion is communicated to the network as the network needs to know when the IoTs are awake. In one embodiment, the communication is via a MI protocol as discussed above. In one embodiment, the communication is via a M2 protocol as discussed above.

FIG. 6C shows an example situation where a plurality (exemplified by two) IoTs 100 are linked to a leader device 110 being serviced in a network comprising at least one network device 200, 210. In this example the leader device 110 receives first level data from the IoTs 100 and substantially simultaneously determines its own second level data in a first step as indicated by the arrows marked 1. In a second step, the data is processed at the leader device 110 as indicated by the arrow marked 2 to determine transceiving occasion (TX/RX). And the transceiving occasion is then communicated to the network as the network is to wake up the IoTs as indicated by the arrows marked 3 so the IoTs are controlled to be awaken (either by the leader device or by the network) and to transmit and/or receive as indicated by the arrow marked 4. In one embodiment, the communication is via a M1 protocol as discussed above. In one embodiment, the communication is via a M2 protocol as discussed above.

FIG. 6D shows an example situation where a plurality (exemplified by two) IoTs 100 are linked to a leader device 110 being serviced in a network comprising at least one network device 200, 210. In this example the leader device 110 receives first level data from the IoTs 100 via the network as there may not be a direct communication link between an IoT and the leader device. Such forwarding is done via a M3 communication protocol. At substantially the same time, the leader device determines its own second level data in a first step as indicated by the arrows marked 1. In a second step, the data is processed at the leader device 110 as indicated by the arrow marked 2 to determine transceiving occasion (TX/RX). And the transceiving occasion is then communicated to the network as the network is to wake up the IoTs as indicated by the arrows marked 3 so the IoTs are controlled to be awaken and to transmit and/or receive as indicated by the arrow marked 4. In one embodiment, the communication between leader and network is via a M1 protocol as discussed above. In one embodiment, the communication between leader and network is via a M2 protocol as discussed above.

FIG. 6E shows an example situation where a plurality (exemplified by two) IoTs 100 are linked to a leader device 110 being serviced in a network comprising at least one network device 200, 210. In this example the network 200, 210 receives first level data from the IoTs 100 via a M3 communication protocol. At substantially the same time, the leader device determines its own second level data in a first step as indicated by the arrows marked 1 and communicates this to the network via a M3 protocol. In a second step, the data is processed at the network 200, 210 as indicated by the arrow marked 2 to determine transceiving occasion (TX/RX). And the IoTs are then woke up as indicated by the arrows marked 3 and the IoTs transmit and/or receive as indicated by the arrow marked 4.

FIG. 6F shows an example situation where a plurality (exemplified by two) IoTs 100 are linked to a leader device 110 being serviced in a network comprising at least one network device 200, 210. In this example the network 200,210 receives first level data from the IoTs 100 via the leader device 110 along with the second level data of the leader device in a first step as indicated by the arrows marked 1. In a second step, the data is processed at the network 200, 210 as indicated by the arrow marked 2 to determine transceiving occasion (TX/RX). And the IoTs are then woke up as indicated by the arrows marked 3 and the IoTs transmit and/or receive as indicated by the arrow marked 4. In one embodiment, the communication is via a M1 protocol as discussed above. In one embodiment, the communication is via a M2 protocol as discussed above.

FIG. 6G shows an example situation where a plurality (exemplified by two) IoTs 100 are linked to a leader device 110 being serviced in a network comprising at least one network device 200, 210. In this example the network 200,210 receives first level data from the IoTs 100 via the leader device 110 along with the second level data of the leader device in a first step as indicated by the arrows marked 1. In a second step, the data is processed at the network 200, 210 as indicated by the arrow marked 2 to determine transceiving occasion (TX/RX). And the IoTs are then woke up via the leader device 110 as indicated by the arrows marked 3 and the IoTs transmit and/or receive as indicated by the arrow marked 4. In one embodiment, the communication is via a M1 protocol as discussed above. In one embodiment, the communication is via a M2 protocol as discussed above.

1-38. (canceled)

39. A method for scheduling transmissions in a network comprising at least one limited device, a leader device and a network device, wherein the method comprises:
linking the at least one limited device to the leader device;
obtaining first level data for the at least one limited device;
obtaining second level data;
processing the first level data and second level data for determining at least one transceiving occasion; and
controlling the at least one limited device to be awake for the at least one transceiving occasion.

40. The method of claim 39, wherein processing the first level data and second level data for determining at least one transceiving occasion is performed by the network device and wherein obtaining second level data is performed by the network device and includes receiving second level data from the leader device.

41. The method of claim 40, wherein obtaining first level data includes one of:
receiving first level data from the at least one limited device;
receiving first level data for the at least one limited device from the leader device; and
retrieving stored first level data.

42. The method of claim 40, wherein:
controlling the at least one limited device to be awake includes the network device controlling the at least one limited device to be awake or includes the network device transmitting the determined at least one transceiving occasion to the leader device and the leader device controlling the at least one limited device to be awake

43. The method of claim 39, wherein:
processing the first level data and second level data for determining at least one transceiving occasion is performed by the leader device; and
obtaining second level data is performed by the leader device determining the second level data.

44. The method of claim 43, wherein:
controlling the at least one limited device to be awake includes the leader device controlling the at least one limited device to be awake or includes the leader device transmitting the determined at least one transceiving occasion to the network device and the network device controlling the at least one limited device to be awake.

45. The method of claim 39, wherein the at least one limited device and the leader device are linked based on mobility measurements and/or based on a determined commonality.

46. The method of claim 39, wherein the first level data comprises one or more taken from a group comprising mobility measurements for the limited device, receive and transmit occasions/time windows that are needed at specific times, estimated amount of data to be transmitted/received, transmission/reception characteristics, operator/supported frequency bands/access methods, supported Radio Access Technologies, preferred Low/Mid/High band, storage capacity limits, and/or strict transmission/reception periods.

47. The method of claim 39, wherein the second level data comprises one or more taken from a group comprising mobility measurements for the leader device, network load, base station location, base station capability, third party apps data, map data, road planning maps, train track maps, time schedules, previous measurements and/or data regarding past interactions with the network.

48. A method for a leader device operating in a network for scheduling transmissions, said network comprising at least one limited device, said leader device and a network device, wherein the method comprises the leader device:
obtaining second level data by determining second level data;
determining at least one transceiving occasion based on second level data and first level data for the at least one limited device; and
controlling the at least one limited device to be awake for the least one transceiving occasion.

49. The method of claim 48, wherein determining the at least one transceiving occasion based on second level data and first level data for the at least one limited device includes:
transmitting second level data to the network device; and
receiving the at least one transceiving occasion.

50. The method of claim 49, further comprising:
receiving first level data for the at least one limited device; and
transmitting first level data to the network device.

51. The method of claim 48, wherein determining the at least one transceiving occasion based on second level data and first level data for the at least one limited device includes:
receiving first level data for the at least one limited device; and
processing the first level data and second level data to determine the at least one transceiving occasion.

52. The method of claim 51, wherein receiving first level data for the at least one limited device includes receiving first level data from the at least one limited device or receiving first level data from the network device.

53. The method of claim 51, wherein controlling the at least one limited device to be awake for the least one transceiving occasion includes transmitting the determined at least one transceiving occasion to the network device.

54. A leader device operating in a network for scheduling transmissions, said network comprising at least one limited device, said leader device and a network device, wherein the leader device comprises a controller configured to:
obtain second level data by determining second level data;
determine at least one transceiving occasion based on second level data and first level data for the at least one limited device; and
control the at least one limited device to be awake for the least one transceiving occasion.

55. The leader device of claim 54, wherein the controller is configured to determine the at least one transceiving occasion based on second level data and first level data for the at least one limited device at least in part by:
transmitting second level data to the network device; and
receiving the at least one transceiving occasion.

56. The leader device of claim 55, wherein the controller is configured to:
receive first level data for the at least one limited device; and
transmit first level data to the network device.

57. The leader device of claim 56, wherein the controller is configured to determine the at least one transceiving occasion based on second level data and first level data for the at least one limited device at least in part by:
receiving first level data for the at least one limited device; and
processing the first level data and second level data to determine the at least one transceiving occasion.
